(19) United States
(12) Patent Application Publication
(10) Pub. No.: US 2010/0172308 A1
(43) Pub. Date: Jul. 8, 2010

(54) SYSTEM AND METHOD FOR DOWNLINK PHYSICAL INDICATOR CHANNEL MAPPING WITH ASYMMETRIC CARRIER AGGREGATION

(75) Inventors: Young-Han Nam, Richardson, TX (US); Jianzhong Zhang, Irving, TX (US)

Correspondence Address: Docket Clerk, P.O. Drawer 800889, Dallas, TX, 75380, US

(73) Assignee: Samsung Electronics Co., Ltd., Suwon-si (KR)

(21) Appl. No.: 12/623,112

(22) Filed: Nov. 20, 2009

Related U.S. Application Data
(60) Provisional application No. 61/204,513, filed on Jan. 7, 2009.

(51) Int. Cl. H04W 72/00; H04L 1/18

(52) U.S. Cl. 370/329; 714/748

(57) ABSTRACT

A base station that communicates with a plurality of subscriber stations in a wireless communications network is configured to allocate downlink physical channel resources in asymmetric carrier systems. The base station includes a transmitter configured to allocate a set of Physical Hybrid Automatic Repeat Request Indicator Channel (PHICH) resources in a downlink carrier. The transmitter can inform, via an uplink grant, a subscriber station regarding one or more PHICH resources from the allocated set of PHICH resources. The base station also includes a receiver that can receive a data communication from the subscriber station within PRBs in a number of uplink carriers that correspond to PRB indices included in the uplink grant. The transmitter can transmit an Acknowledgement/Negative Acknowledgement on the allocated PHICH resources in the downlink carrier such that a PHICH resource is defined by the PRB index and at least one offset value.

### CROSS-REFERENCE TO RELATED APPLICATION(S) AND CLAIM OF PRIORITY

The present application is related to U.S. Provisional Patent No. 61/204,513, filed Jan. 7, 2009, entitled “DOWNLINK PHICH MAPPING WITH ASYMMETRIC CARRIER AGGREGATION”. Provisional Patent No. 61/204,513 is assigned to the assignee of the present application and is hereby incorporated by reference into the present application as if fully set forth herein. The present application hereby claims priority under 35 U.S.C. §119(e) to U.S. Provisional Patent No. 61/204,513.

### TECHNICAL FIELD OF THE INVENTION

The present application relates generally to wireless communications and, more specifically, to a system and method for downlink Hybrid Automatic Repeat Request indicator channel mapping.

### BACKGROUND OF THE INVENTION

Modern communications demand higher data rates and performance. Multiple input, multiple output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

In 3^{rd} Generation Partnership Project (3GPP) Long Term Evolution (LTE) systems, the base station transmits a Downlink (DL) grant to a subscriber station in a Physical Downlink Control Channel (PDCCH). Some frames later, the subscriber station transmits an Acknowledgement (ACK) or Negative Acknowledgement (NACK) to the base station.

### SUMMARY OF THE INVENTION

A base station capable of communicating with at least one of a plurality of subscriber stations in a wireless communications network with asymmetric carriers is provided. The base station includes a transmitter configured to allocate one set of Physical Hybrid Automatic Repeat Request Indicator Channel (PHICH) resources in a downlink carrier. The transmitter is configured to inform, via an uplink grant, at least one subscriber station regarding at least one PHICH resource from the allocated set of PHICH resources. The uplink grant includes at least one Cyclic Shift (CS) index and Physical Resource Block (PRB) indices for each of a plurality of uplink carriers. The base station also includes a receiver configured to receive a data communication from the at least one subscriber station within PRBs in at least one of the plurality of uplink carriers. The PRBs correspond to the PRB indices included in the uplink grant. The transmitter further is configured to transmit an Acknowledgement/Negative Acknowledgement (ACK/NACK) on the allocated at least one PHICH resource in the downlink carrier such that one of the at least one PHICH resource is defined by the PRB index and at least one offset value.

A subscriber station for use in a wireless communications system comprising a plurality of base stations capable of communicating with a plurality of subscriber stations via asymmetric carriers is provided. At least one of the plurality of subscriber stations includes a receiver configured to receive an uplink grant from a base station, the uplink grant indicates an allocation of at least one Physical Hybrid Automatic Repeat Request Indicator Channel (PHICH) resource in a downlink carrier. The PHICH resource is included in one set of PHICH resources allocated in the downlink carrier. The uplink grant includes at least one Cyclic Shift (CS) index and Physical Resource Block (PRB) indices for each of a plurality of uplink carriers. The subscriber station also includes a transmitter configured to send a data communication to the base station within PRBs in at least one of the plurality of uplink carriers. The PRBs correspond to the PRB indices included in the uplink grant. The receiver further is configured to receive an Acknowledgement/Negative Acknowledgement (ACK/NACK) on the allocated at least one PHICH resource in the downlink carrier such that one of the at least one PHICH resource is defined by the PRB index and at least one offset value.

A method for allocating resources in a wireless communications network with asymmetric carriers is provided. The method includes allocating a set of Physical Hybrid Automatic Repeat Request Indicator Channel (PHICH) resources in a downlink carrier. The method also includes informing, via an uplink grant, at least one subscriber station regarding an allocation of at least one PHICH resource included in the allocated set of PHICH resources. The uplink grant includes at least one Cyclic Shift (CS) index and Physical Resource Block (PRB) indices for each of a plurality of uplink carriers. The method further includes receiving, via at least one of a plurality of uplink carriers, a data communication from the at least one subscriber station within PRBs in at least one of the plurality of uplink carriers. The PRBs correspond to the PRB indices included in the uplink grant. Further, the method includes transmitting an Acknowledgement/Negative Acknowledgement (ACK/NACK) on the allocated at least one PHICH resource in the downlink carrier such that one of the at least one PHICH resource is defined by the PRB index and at least one offset value.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an Orthogonal Frequency Division Multiple Access (OFDMA) wireless network that is capable of decoding data streams according to one embodiment of the present disclosure;

FIG. 2A is a high-level diagram of an OFDMA transmitter according to one embodiment of the present disclosure;

FIG. 2B is a high-level diagram of an OFDMA receiver according to one embodiment of the present disclosure;

FIG. 3 illustrates flow messages related to an uplink transmission and an associated Hybrid Automatic Repeat Request (HARQ) ACK/NACK response in an LTE system according to embodiments of the present disclosure;

FIG. 4 illustrates a mapping of control information into Resource Element Groups (REGs) in the LTE DL according to embodiments of the present disclosure;

FIG. 5 illustrates mapping for the UL PRB index and DMRS CS to PHICH resource mapping in a normal cyclic-prefix subframe according to embodiments of the present disclosure;

FIGS. 6A through 6B illustrate asymmetric UL and DL carriers according to embodiments of the present disclosure;

FIG. 7 illustrates a PHICH mapping method according to embodiments of the present disclosure; and

FIG. 8 illustrates another PHICH mapping method according to embodiments of the present disclosure.

### DETAILED DESCRIPTION OF THE INVENTION

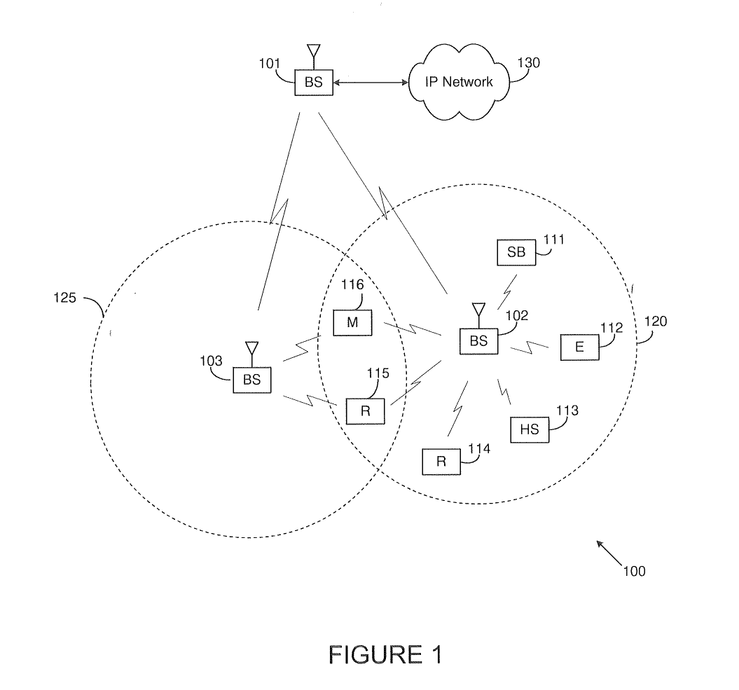

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network.

With regard to the following description, it is noted that the 3GPP Long Term Evolution (LTE) term “node B” is another term for “base station” used below. Also, the LTE term “user equipment” or “UE” is another term for “subscriber station” (or “SS”) used below.

FIG. 1 illustrates exemplary wireless network 100 that is capable of decoding data streams according to one embodiment of the present disclosure. In the illustrated embodiment, wireless network 100 includes base station (BS) 101, base station (BS) 102, and base station (BS) 103. Base station 101 communicates with base station 102 and base station 103. Base station 101 also communicates with Internet protocol (IP) network 130, such as the Internet, a proprietary IP network, or other data network.

Base station 102 provides wireless broadband access to network 130, via base station 101, to a first plurality of subscriber stations within coverage area 120 of base station 102. The first plurality of subscriber stations includes subscriber station (SS) 111, subscriber station (SS) 112, subscriber station (SS) 113, subscriber station (SS) 114, subscriber station (SS) 115 and subscriber station (SS) 116. Subscriber station (SS) may be any wireless communication device, such as, but not limited to, a mobile phone, mobile PDA and any mobile station (MS). In an exemplary embodiment, SS 111 may be located in a small business (SB), SS 112 may be located in an enterprise (E), SS 113 may be located in a WiFi hotspot (HS), SS 114 may be located in a first residence, SS 115 may be located in a second residence, and SS 116 may be a mobile (M) device.

Base station 103 provides wireless broadband access to network 130, via base station 101, to a second plurality of subscriber stations within coverage area 125 of base station 103. The second plurality of subscriber stations includes subscriber station 115 and subscriber station 116. In alternate embodiments, base stations 102 and 103 may be connected directly to the Internet by means of a wired broadband connection, such as an optical fiber, DSL, cable or T1/E1 line, rather than indirectly through base station 101.

In other embodiments, base station 101 may be in communication with either fewer or more base stations. Furthermore, while only six subscriber stations are shown in FIG. 1, it is understood that wireless network 100 may provide wireless broadband access to more than six subscriber stations. It is noted that subscriber station 115 and subscriber station 116 are on the edge of both coverage area 120 and coverage area 125. Subscriber station 115 and subscriber station 116 each communicate with both base station 102 and base station 103 and may be said to be operating in handoff mode, as known to those of skill in the art.

In an exemplary embodiment, base stations 101-103 may communicate with each other and with subscriber stations 111-116 using an IEEE-802.16 wireless metropolitan area network standard, such as, for example, an IEEE-802.16e standard. In another embodiment, however, a different wireless protocol may be employed, such as, for example, a HIPERMAN wireless metropolitan area network standard. Base station 101 may communicate through direct line-of-sight or non-line-of-sight with base station 102 and base station 103, depending on the technology used for the wireless backhaul. Base station 102 and base station 103 may each communicate through non-line-of-sight with subscriber stations 111-116 using OFDM and/or OFDMA techniques.

Base station 102 may provide a T1 level service to subscriber station 112 associated with the enterprise and a fractional T1 level service to subscriber station 111 associated with the small business. Base station 102 may provide wireless backhaul for subscriber station 113 associated with the WiFi hotspot, which may be located in an airport, café, hotel, or college campus. Base station 102 may provide digital subscriber line (DSL) level service to subscriber stations 114, 115 and 116.

Subscriber stations 111-116 may use the broadband access to network 130 to access voice, data, video, video teleconferencing, and/or other broadband services. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer, a laptop computer, a gateway, or another device.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Also, the coverage areas associated with base stations are not constant over time and may be dynamic (expanding or contracting or changing shape) based on changing transmission power levels of the base station and/or the subscriber stations, weather conditions, and other factors. In an embodiment, the radius of the coverage areas of the base stations, for example, coverage areas 120 and 125 of base stations 102 and 103, may extend in the range from less than 2 kilometers to about fifty kilometers from the base stations.

As is well known in the art, a base station, such as base station 101, 102, or 103, may employ directional antennas to support a plurality of sectors within the coverage area. In FIG. 1, base stations 102 and 103 are depicted approximately in the center of coverage areas 120 and 125, respectively. In other embodiments, the use of directional antennas may locate the base station near the edge of the coverage area, for example, at the point of a cone-shaped or pear-shaped coverage area

The connection to network 130 from base station 101 may comprise a broadband connection, for example, a fiber optic line, to servers located in a central office or another operating company point-of-presence. The servers may provide communication to an Internet gateway for internet protocol-based communications and to a public switched telephone network gateway for voice-based communications. In the case of voice-based communications in the form of voice-over-IP (VoIP), the traffic may be forwarded directly to the Internet gateway instead of the PSTN gateway. The servers, Internet gateway, and public switched telephone network gateway are not shown in FIG. 1. In another embodiment, the connection to network 130 may be provided by different network nodes and equipment.

In accordance with an embodiment of the present disclosure, one or more of base stations 101-103 and/or one or more of subscriber stations 111-116 comprises a receiver that is operable to decode a plurality of data streams received as a combined data stream from a plurality of transmit antennas using an MMSE-SIC algorithm. As described in more detail below, the receiver is operable to determine a decoding order for the data streams based on a decoding prediction metric for each data stream that is calculated based on a strength-related characteristic of the data stream. Thus, in general, the receiver is able to decode the strongest data stream first, followed by the next strongest data stream, and so on. As a result, the decoding performance of the receiver is improved as compared to a receiver that decodes streams in a random or pre-determined order without being as complex as a receiver that searches all possible decoding orders to find the optimum order.

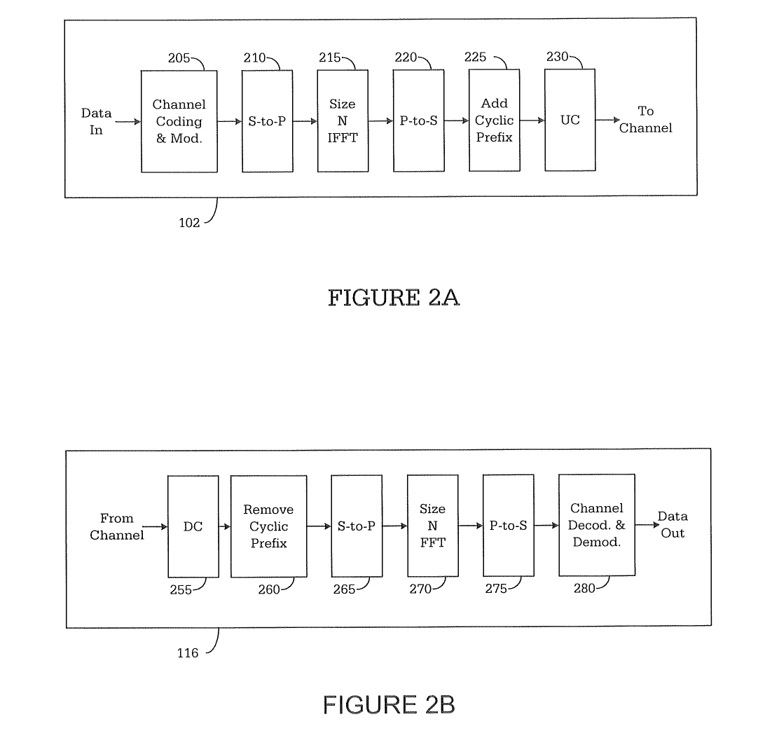

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in subscriber station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

The present disclosure describes methods and systems to convey information relating to base station configuration to subscriber stations and, more specifically, to relaying base station antenna configuration to subscriber stations. This information can be conveyed through a plurality of methods, including placing antenna configuration into a quadrature-phase shift keying (QPSK) constellation (e.g., n-quadrature amplitude modulation (QAM) signal, wherein n is 2̂x) and placing antenna configuration into the error correction data (e.g., cyclic redundancy check (CRC) data). By encoding antenna information into either the QPSK constellation or the error correction data, the base stations 101-103 can convey base stations 101-103 antenna configuration without having to separately transmit antenna configuration. These systems and methods allow for the reduction of overhead while ensuring reliable communication between base stations 101-103 and a plurality of subscriber stations.

In some embodiments disclosed herein, data is transmitted using QAM. QAM is a modulation scheme which conveys data by modulating the amplitude of two carrier waves. These two waves are referred to as quadrature carriers, and are generally out of phase with each other by 90 degrees. QAM may be represented by a constellation that comprises 2̂x points, where x is an integer greater than 1. In the embodiments discussed herein, the constellations discussed will be four point constellations (4-QAM). In a 4-QAM constellation a 2 dimensional graph is represented with one point in each quadrant of the 2 dimensional graph. However, it is explicitly understood that the innovations discussed herein may be used with any modulation scheme with any number of points in the constellation. It is further understood that with constellations with more than four points additional information (e.g., reference power signal) relating to the configuration of the base stations 101-103 may be conveyed consistent with the disclosed systems and methods.

It is understood that the transmitter within base stations 101-103 performs a plurality of functions prior to actually transmitting data. In the 4-QAM embodiment, QAM modulated symbols are serial-to-parallel converted and input to an inverse fast Fourier transform (IFFT). At the output of the IFFT, N time-domain samples are obtained. In the disclosed embodiments, N refers to the IFFT/fast Fourier transform (FFT) size used by the OFDM system. The signal after IFFT is parallel-to-serial converted and a cyclic prefix (CP) is added to the signal sequence. The resulting sequence of samples is referred to as an OFDM symbol.

At the receiver within the subscriber station, this process is reversed, and the cyclic prefix is first removed. Then the signal is serial-to-parallel converted before being fed into the FFT. The output of the FFT is parallel-to-serial converted, and the resulting QAM modulation symbols are input to the QAM demodulator.

The total bandwidth in an OFDM system is divided into narrowband frequency units called subcarriers. The number of subcarriers is equal to the FFT/IFFT size N used in the system. In general, the number of subcarriers used for data is less than N because some subcarriers at the edge of the frequency spectrum are reserved as guard subcarriers. In general, no information is transmitted on guard subcarriers.

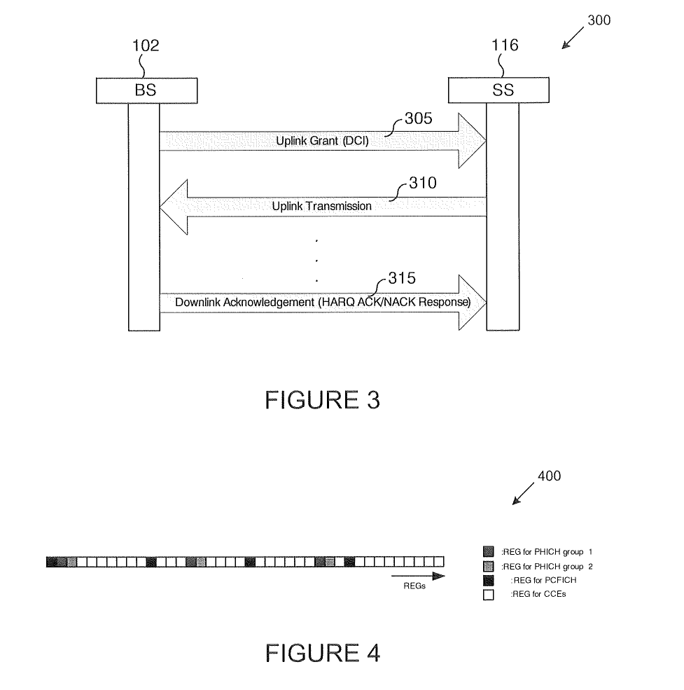

FIG. 3 illustrates flow messages related to an uplink transmission and an associated Hybrid Automatic Repeat Request (HARQ) ACK/NACK response in an LTE system according to embodiments of the present disclosure. The embodiment of the flow messages 300 illustrated in FIG. 3 are for illustration only and other embodiments could be used without departing from the scope of this disclosure.

In a wireless communication system, such as, for example, in an LTE system, a UL transmission for SS 116 is initiated by BS 102. BS 102 sends SS 116 a UL grant 305 containing the indices of the Physical Resource Blocks (PRBs) and the Demodulation Reference Signal Cyclic Shift (DMRS CS) index assigned to SS 116. The UL grant 305 indicates which PRB SS 116 can use for its UL transmission and which DMRS CS can be used for DMRS generation. Upon receiving the UL grant 305 in a subframe, SS 116 transmits, in an UL transmission 310, packets to BS 102. BS 102 attempts to decode the packets received from SS 116 in the UL transmission 310. Depending upon the decoding result by BS 102, BS 102 sends an ACK or NACK 315 within a few subframes later (i.e., a subsequent subframe). BS 102 sends the ACK/NACK 315 through a Physical HARQ Indicator Channel (PHICH). The PHICH is a dedicated channel for the ACK/NACK (A/N) 315. If BS 102 successfully decodes the received packets, BS 102 sends an ACK, otherwise, BS 102 sends a NACK.

In the 3GPP LTE standard, described in 3GPP TS 36.211 V8.4.0, “3^{rd} Generation Partnership Project; Technical Specification Group Radio Access Network; Evolved Universal Terrestrial Radio Access (E-UTRA); Physical Channels and Modulation (Release 8)”, September 2008, the contents of which are hereby incorporated by reference, a PHICH is defined for carrying the HARQ ACK/NAK. Multiple PHICHs mapped to the same set of resource elements constitute a PHICH group, where PHICHs within the same PHICH group are multiplexed through different orthogonal sequences. A PHICH resource is identified by the index pair

$$( {n}_{PHICH}^{group} , {n}_{PHICH}^{seq} ) ,$$

where

$${n}_{PHICH}^{group}$$

is the PHICH group number and

$${n}_{PHICH}^{seq}$$

is the orthogonal sequence index within the group as defined in Table 1 below.

TABLE 1

| | Orthogonal sequence | |
|---|---|---|
| $\begin{matrix}Sequence index \\ {n}_{PHICH}^{seq}\end{matrix}$ | $\begin{matrix}Normal cyclic prefix \\ {N}_{SF}^{PHICH} = 4\end{matrix}$ | $\begin{matrix}Extended cyclic prefix \\ {N}_{SF}^{PHICH} = 2\end{matrix}$ |
| 0 | [+1 +1 +1 +1] | [+1 +1] |
| 1 | [+1 −1 +1 −1] | [+1 −1] |
| 2 | [+1 +1 −1 −1] | [+j +j] |
| 3 | [+1 −1 −1 +1] | [+j −j] |
| 4 | [+j +j +j +j] | — |
| 5 | [+j −j +j −j] | — |
| 6 | [+j +j −j −j] | — |
| 7 | [+j −j −j +j] | — |

Since each PHICH group includes four (4) or eight (8) PHICH sequences, depending on whether a DL subframe is normal or extended cyclic-prefix subframe, the total number of PHICH resources in a DL subframe

$${N}_{PHICH}^{resources}$$

is given by either

$$8 {n}_{PHICH}^{group} or 4 {n}_{PHICH}^{group} .$$

The PHICH resources are indexed by an index n, where

$$n = 0 , … , {N}_{PHICH}^{resources} - 1.$$

Furthermore, both BS 102 and SS 116 use the same index in order to exchange information.

FIG. 4 illustrates a mapping of control information into Resource Element Groups (REGs) in the LTE DL according to embodiments of the present disclosure. The embodiment of the mapping 400 shown in FIG. 4 is for illustration only. Other embodiments could be used without departing from the scope of this disclosure.

The PHICH resources in a PHICH group are mapped to three Resource Element Groups (REGs), where an REG includes four Resource Elements (REs). First, a set of REGs are reserved for a Physical Control Format Indicator Channel (PCFICH), and then a set of REGs are reserved for the PHICH groups. Finally, the remaining REGs are aggregated to Control Channel Elements (CCEs), where one CCE includes nine REGs. A few CCEs can be further aggregated to form a Physical Downlink Control Channel (PDCCH). In the LTE system, a set of CCEs are configured as a common search space. For each SS (e.g., for SS 111-116), BS 102 configures another set of CCEs as a UE-specific search space. In a subframe, SS 116 (i.e., an active UE) searches for its Downlink Control Information (DCI) in these two sets of CCEs.

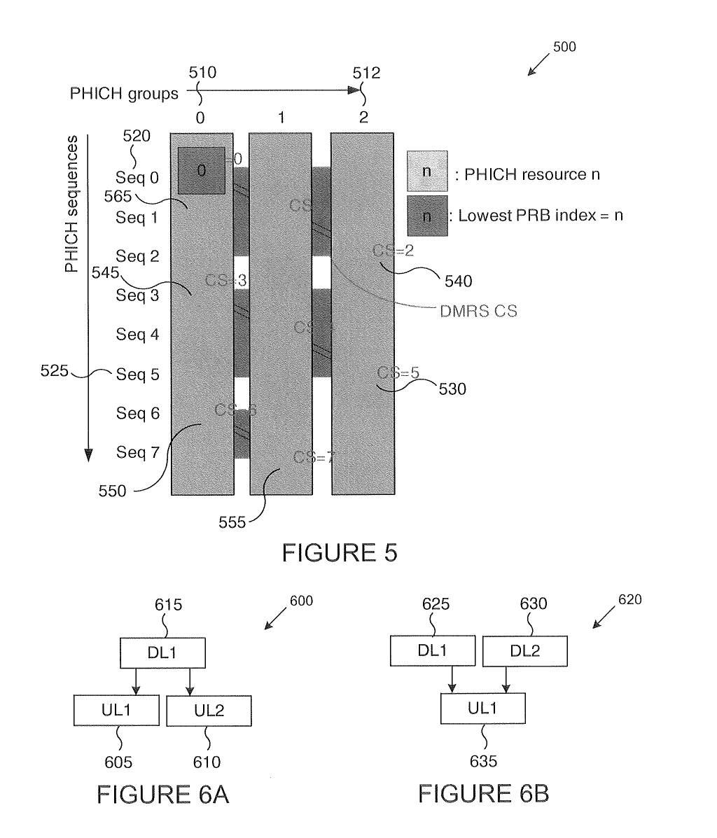

FIG. 5 illustrates mapping for the UL PRB index and DMRS CS to PHICH resource mapping in a normal cyclic-prefix subframe according to embodiments of the present disclosure. The embodiment of the mapping 500 shown in FIG. 5 is for illustration only. Other embodiments could be used without departing from the scope of this disclosure.

A PHICH resource for transmitting a hybrid-ARQ ACK/NACK for SS 116 at BS 102 can be identified by the UL PRB indices used for the UL transmission for SS 116. The UL PRB indices can be sent to SS 116 by BS 102 along with the UL transmission grant. In 3GPP 36.213, the linkage from the UL PRB indices and the DMRS CS index to a PHICH resource is as follows. A PHICH resource

$$( {n}_{PHICH}^{group} , {n}_{PHICH}^{seq} )$$

is assigned based on the lowest PRB index of a UE,

$${I}_{PRB \_ RA}^{lowest \_ index}$$

and DMRS CS index n_{DMRS} according to Equation 1:

$${n}_{PHICH}^{group} = ( {I}_{PRB \_ RA}^{lowest \_ index} + {n}_{DMRS} ) mod {N}_{PHICH}^{group} \\ {n}_{PHICH}^{seq} = ( ⌊ \frac{{I}_{PRB \_ RA }^{lowest \_ index}}{{N}_{PHICH}^{group}} ⌋ + {n}_{DMRS} ) mod 2 {N}_{SF}^{PHICH} . \qquad [ Eqn . 1 ]$$

In Equation 1: n_{DMRS} is the DMRS CS used in the UL transmission for which the PHICH is related;

$${N}_{SF}^{PHICH}$$

is the spreading factor size used for PHICH;

$${I}_{PRB \_ RA}^{lowest \_ index}$$

is the lowest index PRB of the uplink resource allocation; and

$${N}_{PHICH}^{group}$$

is the number of PHICH groups configured.

The PHICH resource index n is associated with

$$( {n}_{PHICH}^{group} , {n}_{PHICH}^{seq} )$$

as follows:

$$n = {n}_{PHICH}^{group} + {n}_{PHICH}^{seq} \cdot {N}_{PHICH}^{group} \qquad [ Eqn . 2 ]$$

In 3GPP LTE 36.211, the number of PHICH groups

$${N}_{PHICH}^{group}$$

is constant in all the DL subframes in a Frequency-Division Duplex (FDD) system, and defined by Equation 3:

$${N}_{PHICH}^{group} = \{ \begin{matrix}⌈ {N}_{g} ( \frac{{N}_{RB}^{DL}}{8} ) ⌉ & for normal cyclic prefix \\ 2 \cdot ⌈ {N}_{g} ( \frac{{N}_{RB}^{DL}}{8} ) ⌉ & for extended cyclic prefix\end{matrix} \qquad [ Eqn . 3 ]$$

where N_{g}ε{1/6,1/2,1,2} is provided by higher layers and

$${N}_{RB}^{DL}$$

is the total number of DL RBs in the DL bandwidth. The index

$${n}_{PHICH}^{group}$$

ranges from 0 to

$${N}_{PHICH}^{group} - 1.$$

In the example illustrated in FIG. 5, the total number of RBs in the UL bandwidth is twelve (12), and N_{g}=2. Therefore, three (3) PHICH groups are available, i.e.,

$${n}_{PHICH}^{group} = 3.$$

When the lowest PRB index is

$${I}_{PRB \_ RA}^{lowest \_ index}$$

and the DMRS CS n_{DMRS} is ‘0’, the PHICH resource

$${I}_{PRB \_ RA}^{lowest \_ index}$$

is determined for the HARQ ACK/NACK transmission. For example, when the lowest PRB index is zero (0) and the DMRS CS is zero (0) in the UL grant for SS 116, the PHICH group zero (0) 510 and PHICH sequence zero (0) 520 is assigned for the corresponding HARQ ACK/NACK transmission to SS 116. Conversely, when the lowest PRB index is

$${I}_{PRB\_RA}^{lowest\_index}$$

and the DMRS CS n_{DMRS} is nonzero, the selected PHICH resource is located at a position diagonally (to the right, to the bottom, and wrapping around) proceeded from

$${I}_{PRB\_RA}^{lowest\_index}$$

by n_{DMRS} times. For example, when the lowest PRB index is zero (0) and the DMRS CS is five (5) in the UL grant, PHICH resource seventeen (17) 530, i.e., PHICH group two (2) 512 and PHICH sequence five (5) 525 is assigned.

FIGS. 6A-6B illustrate Asymetric Carrier Aggregation according to embodiments of the present disclosure. The embodiments of the carrier aggregation 600 and 620 shown in FIGS. 6A and 6B respectively are for illustration only. Other embodiments of the carrier aggregation 600, 620 could be used without departing from the scope of this disclosure.

As opposed to the LTE system which operates in a single contiguous bandwidth (or in a single carrier), next generation communication systems (for example, LTE-Advanced and WiMax) allow the aggregation of multiple bandwidths for SS 116 and for BS 102 to operate in the resultant aggregated carriers. The bandwidth aggregation can be asymmetric, implying that the number of carriers in the UL and the downlink (DL) can be different. In some embodiments, as shown in FIG. 6A, there are more UL carriers 605, 610 than DL carriers 615. In some embodiments shown in FIG. 6B, there are more DL carriers 625, 630 than UL carriers 635.

For an UL transmission by SS 116, BS 102 first sends a UL grant informing SS 116 regarding the allocated RBs. The allocated RBs can be over multiple UL carriers. Upon receiving the UL grant intended for SS 116 in a subframe, SS 116 transmits packets using the allocated RBs to BS 102. Upon receiving the packets from SS 116, BS 102 attempts to decode the packets. BS 102 sends a HARQ ACK to SS 116 within a few subsequent sub-frames if BS 102 successfully decodes the packets. If BS 102 fails to decode the packets, BS 102 sends, within a few subsequent sub-frames, a HARQ NACK to SS 116. BS 102 sends the HARQ ACK/NACK bits through the PHICH. The UL grant has necessary information, the UL PRB indices and DM-RS CS index, required for identifying the PHICH resource used for sending the ACK/NACK (AN) bits associated with the UL transmission, and this information is available at both BS 102 and SS 116.

In wireless communication systems with only one pair of DL and UL carriers, the identification of the PHICH resource using the UL PRB indices and the DMRS-CS index in a UL grant is defined by the 3GPP LTE specification 36.213. Embodiments of the present disclosure provide, for wireless communication systems that include multiple UL carriers and one DL carrier as illustrated in FIG. 6A, ways of feeding back information on multiple ACK/NACK bits associated with a UL transmission in multiple UL component carriers to SS 116. Embodiments of the present disclosure further provide mapping rules between UL PRB indices in the UL carriers and PHICH resources in the DL carrier.

SS 116 can be one of two different types (e.g., categories) of subscriber stations that exist in a new system with carrier aggregation. SS 116 can be a legacy subscriber station that follows the PHICH mapping rule in the LTE and receives only one AN bit through the PHICH. Alternatively, SS 116 can be an advance subscriber station that follows the new PHICH mapping rule and is capable of receiving multiple AN bits through the PHICHs.

SS 116, as either the legacy subscriber stations or the advanced subscriber station, is informed by BS 102 of the total number of DL RBs in the DL bandwidth

$${N}_{RB}^{DL}$$

and a parameter N_{g}ε{1/6,1/2,1,2}.

$${N}_{RB}^{DL}$$

is carried in primary broadcast channel (PBCH) or through a higher-layer signaling, and N_{g} is provided by the higher layer. In embodiments where SS 116 is an advanced subscriber station (herein after also referred to as “advanced SS” 116 or SS-A 116), BS 102 informs SS 116 of the assigned UL and DL carriers. The total number of UL component carriers in the system is denoted by

$${N}_{carriers}^{UL} ,$$

and these carriers are numbered as

$$i = 0 , 1 , … , {N}_{carriers}^{UL} - 1.$$

In some embodiments, an advanced SS 116 receives DL acknowledgement in response to an uplink transmission according to two alternatives.

In some embodiments, referred herein after as “alternative_{—}1” embodiments, “first alternative” or simply “alternative_{—}1”), a mapping rule from the UL PRB indices and the DMRS CSs in multiple UL carriers to a single PHICH index is defined. According to the mapping rule, only one bit information on the DL acknowledgement is sent through the PHICH. BS 102 may calculate one bit information to send. BS 102 sends the one bit information by bundling the AN bits. The AN bits are combined, or bundled, by taking a logical AND operation on multiple bits, each of which is either a zero (0) or a one (1) depending on the decoding result in each UL carrier. If the decoding result in a UL carrier is successful, the bit is one; otherwise, the bit is zero. In some embodiments, if the decoding result is successful, the bit is zero; otherwise the bit is one.

For example, referring back to FIG. 6A, two packets are transmitted in UL1 605 and UL2 610. BS 102 decodes the two packets. BS 102 can send two separate ACK/NACKs for those two packets. Alternatively, BS 102 can combine the two ACK/NACKS into a single bit ACK/NACK Response. Therefore, if BS 102 successfully decodes both packets, instead of sending two ACKS (i.e., ACK/ACK), BS 102 sends a ‘1’ (e.g., an ACK). However, if BS 102 successfully decodes one packet but not the other, instead of sending an ACK and a NACK, BS 102 sends a ‘0’ (e.g., a NACK). Further, BS 102 can send a ‘0’ (e.g., a NACK) if neither packet is decoded successfully.

In alternative_{—}1 embodiments, the UL PRB index is defined by selecting one of the UL PRB indices as the index to be used. For example, a single PHICH index is selected from among the PHICH indices calculated using Equation 1 with multiple lowest UL PRB indices in the UL carriers where an advanced SS 116 has sent packets. Therefore, For this purpose, SS-A 116 can be semi-statically configured by BS 102 to select one primary UL carrier, from whose lowest PRB index and DMRS CS SS-A 116 can find a PHICH index. BS 102 explicitly informs SS-A 116 regarding the UL PRB selection. BS 102 may change the UL PRB selection sporadically, informing SS-A 116 after each change. BS 102 can inform SS-A 116 regarding the UL PRB selection via higher layer signaling.

In some embodiments, herein after referred to as “alternative_{—}2” embodiments, “second alternative” or simply as “alternative_{—}2”, multiple ACK/NACK bits are sent by BS 102. For the sending of information on these multiple ACK/NACK bits, a mapping rule from the UL PRB indices and the DMRS CSs in multiple UL carriers to a corresponding number of PHICH indices is defined. In such alternative_{—}2 embodiments, the corresponding number of ACK/NACK bits are sent through the assigned PHICHs.

For alternative_{—}2 embodiments, PHICH resources in a primary DL carrier can be allocated using different methods (i.e., allocated in different ways). Each UL carrier may include a different number of PHICH groups. For example, a first UL carrier may include a different number of PHICH groups from a second UL carrier. The assignment of different numbers of PHICH groups can be performed via higher layer signals or via an implicit relationship.

In one alternative_{—}2 embodiment, referred as method_{—}2-1, a single set of PHICH resources in a primary DL carrier is allocated. In one example, the set of PHICH resources is allocated in the same manner as in the LTE system. Accordingly, both legacy UEs, such as for example SS 115 (a legacy UE or when SS 116 is a legacy UE), and advanced UEs, such as for example SS-A 116, obtain the number of PHICH groups

$${N}_{PHICH}^{group} ,$$

using Equation 3 with parameters

$${N}_{RB}^{DL}$$

and N_{g}. The PHICH resources given by these

$${N}_{PHICH}^{group}$$

PHICH groups are used for carrying ACK/NACK bits for the UL transmissions in multiple UL carriers.

In some embodiments of method_{—}2-1, a PHICH resource is determined by a subset of the UL PRB indices, a DMRS CS index and a UL PHICH offset index and a UL PHICH sequence wrap-around index, associated with a UL component carrier. The smallest UL PRB index, the DMRS CS index, the UL PHICH offset index and the UL PHICH sequence wrap-around index in UL carrier i are denoted by

$${I}_{PRB\_RA}^{lowest\_index} ( i ) , {n}_{DMRS} ( i ) , {I}_{PRB\_RA}^{offset} ( i ) and {I}_{sequence}^{wrap \text{-} around} ( i )$$

respectively. SS-A 116 obtains the UL PHICH offset indices

$$( i . e . , {I}_{PRB\_RA}^{offset} ( i ) )$$

and the UL PHICH sequence wrap-around indices

$$( i . e . , {I}_{sequence}^{wrap \text{-} around} ( i ) )$$

associated with multiple UL carriers either via an explicit signaling from BS 102, or via an implicit relation of parameters sent by a higher-layer signaling or in broadcasted information. The PHICH resource mapping associated with UL carrier i is done in the following two example methods.

In one example method (hereinafter referred to as method_{—}2-1-A), a PHICH resource associated with transmission in UL PRBs in UL carrier i is determined such that the PHICH resource index is offset by

$${I}_{PRB\_RA}^{offset} ( i )$$

as compared to the PHICH resource index in defined in Equation 2. With the DMRS CS equal to zero (that is, n_{DMRS}(i)=0), the PHICH resource can be determined by

$$n ( i ) = {I}_{PRB\_RA}^{offset} ( i ) + {I}_{PRB\_RA}^{lowest\_index} ( i ) ,$$

where

$$n ( i ) = {n}_{PHICH}^{group} ( i ) + {n}_{PHICH}^{seq} ( i ) \cdot {N}_{PHICH}^{group} .$$

Referring back to FIG. 5, as the DMRS CS increases, the PHICH resource index proceeds from the left to the right and from top to the bottom, once it reaches the lowest element, it wraps around to the top, while it reaches the rightmost element, it wraps around to the left. For example, the PHICH resource index proceeds from PHICH resource eight (8) 540 (when the DMRS CS=2) to PHICH resource nine (9) 545 (when the DMRS CS=3); from PHICH resource seventeen (17) 530 (when the DMRS CS=5) to PHICH resource eighteen (18) 550 (when the DMRS CS=6); and from PHICH resource twenty-two (22) 555 (when the DMRS CS=7) to PHICH resource zero (0) 560. Therefore, a PHICH resource n(i) can be determined using Equations 4 and 5:

$$\begin{matrix}{n}_{PHICH}^{group} ( i ) = ( \begin{matrix}{I}_{PRB\_RA}^{offset} ( i ) + {I}_{PRB\_RA}^{lowest\_index} ( i ) + \\ {n}_{DMRS} ( i )\end{matrix} ) {mod N}_{PHICH}^{group} , & [ Eqn . 4 ] \\ {n}_{PHICH}^{seq} ( i ) = ( ⌊ \frac{( \begin{matrix}{I}_{PRB\_RA}^{offset} ( i ) + \\ {I}_{PRB\_RA}^{lowest\_index} ( i )\end{matrix} )}{{N}_{PHICH}^{group}} / ⌋ + {n}_{DMRS} ( i ) ) mod 2 {N}_{SF}^{PHICH} & [ Eqn . 5 ]\end{matrix}$$

where

$${N}_{PHICH}^{group}$$

is the number of PHICH groups configured

$${N}_{SF}^{PHICH}$$

is the spreading factor size used for PHICH.

In another method (referred hereinafter as method_{—}2-1-B), a PHICH resource associated with transmission in UL PRBs in UL carrier i can be determined as follows: (1) the PHICH group index can be determined in the same manner as in method_{—}2-1-A; or (2) the PHICH sequence index can be determined such that the PHICH sequence index always is greater than

$${I}_{sequence}^{wrap \text{-} around} ( i ) ,$$

by wrapping around the sequence to

$${I}_{sequence}^{wrap \text{-} around} ( i ) .$$

Similar to method_{—}2-1-A, with the DMRS CS equal to zero, or n_{DMRS}(i)=0, the PHICH resource is determined by

$$n ( i ) = {I}_{PRB\_RA}^{offset} ( i ) + {I}_{PRB\_RA}^{lowest\_index} ( i ) .$$

Referring back to FIG. 5, as the DMRS CS increases, the PHICH resource index proceeds from the left to the right and from top to the bottom just. However, the wrap-around behavior is different from method_{—}2-1-A in that: once it reaches the lowest element, it wraps around not to the top, but to the

$$( {I}_{sequence }^{wrap - around} ( i ) + 1 ) - th$$

position from the top. However, when it reaches the rightmost element, it wraps around to the left. For example, the PHICH resource index proceeds from PHICH resource eight (8) 540 (when the DMRS CS=2) to PHICH resource nine (9) 545 (when the DMRS CS=3); from PHICH resource seventeen (17) 530 (when the DMRS CS=5) to PHICH resource eighteen (18) 550 (when the DMRS CS=6); and from PHICH resource twenty-two (22) 555 (when the DMRS CS=7) to PHICH resource three (3) 565. Accordingly, the PHICH sequence index can be determined by Equations 7, 8 and 9:

$$\begin{matrix}if ⌊ ( {I}_{PRB\_RA}^{offset} ( i ) + {I}_{PRB\_RA}^{lowest\_index} ( i ) ) / {N}_{PHICH}^{group} ⌋ + {n}_{DMRS} ( i ) < 2 {N}_{SF}^{PHICH} & [ Eqn . 7 ] \\ {n}_{PHICH}^{seq} ( i ) = ⌊ ( {I}_{PRB\_RA}^{offset} ( i ) + {I}_{PRB\_RA}^{lowest\_index} ( i ) ) / {N}_{PHICH}^{group} ⌋ + {n}_{DMRS} ( i ) . \\ otherwise , & [ Eqn . 8 ] \\ {n}_{PHICH}^{seq} ( i ) = ( \begin{matrix}\begin{matrix}{I}_{sequence}^{wrap \text{-} around} ( i ) + \\ ⌊ ( \begin{matrix}{I}_{PRB\_RA}^{offset} ( i ) + \\ {I}_{PRB\_RA}^{lowest\_index} ( i )\end{matrix} ) / {N}_{PHICH}^{group} ⌋ +\end{matrix} \\ {n}_{DMRS} ( i )\end{matrix} ) mod2 {N}_{SF}^{PHICH} . & [ Eqn . 9 ]\end{matrix}$$

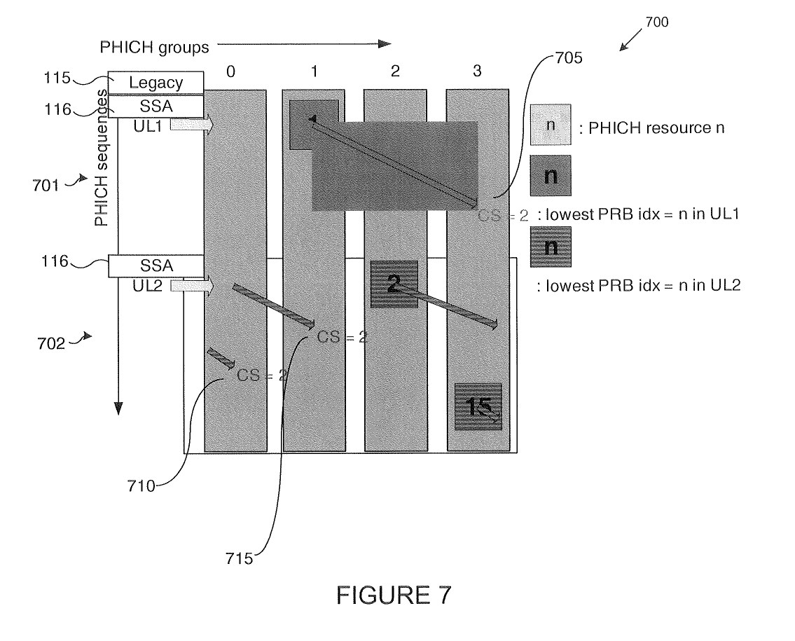

FIG. 7 illustrates a PHICH mapping method according to embodiments of the present disclosure. The embodiment of the PHICH mapping 700 shown in FIG. 7 is for illustration only. Other embodiments could be used without departing from the scope of this disclosure.

In some embodiments, the UL PHICH offset indices in multiple component carriers can be determined implicitly by a function of the number of component carriers and the number of PHICH groups assigned in a DL carrier.

In one example function, the UL PHICH offset indices can evenly divide the assigned PHICH resources in the DL bandwidth. For example,

$${N}_{PHICH}^{resources}$$

PHICH resources in the DL bandwidths are partitioned into

$${N}_{carriers}^{UL}$$

sets of resources having adjacent PHICH resource indices, and the lowest PHICH resource index of set i is indicated by the UL PHICH offset indices

$${I}_{PRB\_RA}^{offset} ( i ) = ⌊ i {N}_{PHICH}^{resources} / {N}_{carriers}^{UL} ⌋ , i = 0 , 1 , … , {N}_{carriers}^{UL} - 1.$$

For example, a first set of PHICH resources 701 can include PHICH resources 0-15 while a second set of PHICH resources 702 can include PHICH resources 16-31. Accordingly, using the offset equations, a first UL carrier can be allocated the first set of PHICH resources 701 and a second UL carrier can be allocated the second set of PHICH resources 702. Furthermore, using this function, all carriers are weighted equally and the PHICH resources are divided equally.

In another example function, the PHICH resources can be divided evenly into two In some such embodiments, the second half of the PHICH resources further can be divided evenly by the UL PHICH offset indices. For example,

$${N}_{PHICH}^{resources} / 2$$

PHICH resources in the second half can be partitioned into

$${N}_{carriers}^{UL}$$

sets of resources having adjacent PHICH resource indices, and the lowest PHICH resource index of set i is indicated by the UL PHICH offset indices

$${I}_{PRB\_RA}^{offset} ( i ) = {N}_{PHICH}^{resources} / 2 + ⌊ i {N}_{PHICH}^{resources} / 2 {N}_{carriers}^{UL} ⌋ , \\ i = 0 , 1 , … , {N}_{carriers} - 1.$$

For example, a first set of PHICH resources 701 can include PHICH resources 0-15 while a second set of PHICH resources 702 can include PHICH resources 16-31. Accordingly, using the offset equations, a first UL carrier can be allocated the first set of PHICH resources 701 and a second UL carrier can be allocated the second set of PHICH resources 702. Furthermore, using this function, a first UL carrier is allocated the first set of PHICH resources 701 while the remaining UL carriers share the second set of PHICH resources 702.

For example, SS-A 116 can be allocated the first set of PHICH resources 701. SS-A 116 starts with PHICH resource one (1) (PHICH Group ‘1’ and PHICH Sequence ‘1’) as the lowest PRB index in UL_1 (the first UL carrier). When the DMRS CS=2, SS-A 116 is allocated PHICH resource eleven (11). In some embodiments, SS-A 116 will wraparound and proceed to PHICH resource twelve (12) and further to PHICH resource one (1) again depending upon the DMRS CS. In some embodiments, SS-A 116 will wraparound and proceed to PHICH resource twelve (12) and further to PHICH resource seventeen (17) depending upon the DMRS CS. Additionally, SS-A 116 starts with PHICH resource eighteen (18) (i.e., PHICH resource two (2) in UL_2) (PHICH Group ‘0’ and PHICH Sequence ‘4’) as the lowest PRB index in UL_2 (the second UL carrier). When the DMRS CS=2, SS-A 116 proceeds to use PHICH resource twenty-one (21). In some embodiments, SS-A 116 proceeds and wraps-around to use PHICH resource twenty-four (24), depending upon the DMRS CS and so forth. In some embodiments, when a third UL carrier is present, SS-A 116 proceeds and wraps-around to use PHICH resource sixteen (16), then PHICH resource twenty-one (21), then again to PHICH resource eighteen (18), depending upon the DMRS CS, and so forth. For the third UL carrier, SS-A 116 starts with PHICH resource thirty-one (31) (i.e., PHICH resource fifteen (15) in UL_2) (PHICH Group ‘3’ and PHICH Sequence ‘7’) as the lowest PRB index in UL_2 (the second UL carrier). When the DMRS CS=2, SS-A 116 proceeds to use PHICH resource twenty-four (24). SS-A 116 will proceed to PHICH resource twenty-nine (29), then PHICH resource twenty-six (26), depending upon the DMRS CS, and so forth.

In some embodiments, the UL PHICH sequence wrap-around indices in multiple component carriers can be determined implicitly by a function of a subset of parameters including the number of component carriers, the UL PHICH offset indices and the number of PHICH groups assigned in a DL carrier. In one example, the UL PHICH sequence wrap-around index for UL carrier i is the PHICH sequence index obtained using Equation 1 and substituting the lowest PRB index by the UL PHICH offset index and the DMRS CS by ‘0’, i.e.,

$${I}_{sequence}^{wrap \text{-} around} ( i ) = ( ⌊ {I}_{PRB\_RA}^{offset} ( i ) / {N}_{PHICH}^{group} ⌋ ) mod2 {N}_{SF}^{PHICH} , ∀ i .$$

In another example, the UL PHICH wrap-around index for UL carrier i is the same as the PHICH sequence index obtained Equation 1 and substituting the lowest PRB index by the UL PHICH offset index of the first UL carrier and the DMRS CS by ‘0’, i.e.,

$${I}_{sequence}^{wrap \text{-} around} ( i ) = ( ⌊ {I}_{PRB\_RA}^{offset} ( 0 ) / {N}_{PHICH}^{group} ⌋ ) mod2 {N}_{SF}^{PHICH} , ∀ i .$$

In an additional example of method_{—}2-1, BS 102 informs SS 116 (or SS-A 116), that

$${N}_{carriers}^{UL} = 2 and {N}_{PHICH}^{group} = 4.$$

In a normal cyclic-prefix subframe,

$${N}_{PHICH}^{resources} = 32 ,$$

thus,

$${I}_{PRB\_RA}^{offset} ( 0 ) = 0 and {I}_{PRB\_RA}^{offset} ( 1 ) = 16$$

can be obtained from an implicit relation

$${I}_{PRB\_RA}^{offset} ( i ) = ⌊ {iN}_{PHICH}^{resources} / {N}_{carriers}^{UL} ⌋ .$$

In the example illustrated in FIG. 7, the PHICH mapping 700 includes

$${N}_{carriers}^{UL} = 2 , {N}_{PHICH}^{group} = 4 , {I}_{PRB\_RA}^{offset} ( 0 ) = 0 and {I}_{PRB\_RA}^{offset} ( 1 ) = 16$$

based on method_{—}2-1. In embodiments using method_{—}2-1-A, with

$${n}_{DMRS} ( 0 ) = {n}_{DMRS} ( 1 ) = 2 , {I}_{PRB\_RA}^{lowest\_index} ( 0 ) = 1$$

$$and {I}_{PRB\_RA}^{lowest\_index} ( 1 ) = 2 ,$$

the PHICH resources assigned for the recent transmission in UL carriers ‘0’ 701 and ‘1’ 702 are PHICH resource elevent (11) 705, i.e.,

$$( {n}_{PHICH}^{group} , {n}_{PHICH}^{seq} ) = ( 3 , 2 ) ,$$

and PHICH resource twenty-four (24) 710, i.e.,

$$( {n}_{PHICH}^{group} , {n}_{PHICH}^{seq} ) = ( 0 , 6 ) ,$$

respectively. In embodiments using method_{—}2-1-B, with

$${n}_{DMRS} ( 0 ) = {n}_{DMRS} ( 1 ) = 2 , \\ {I}_{PRB\_RA}^{lowest\_index} ( 0 ) = 1 , {I}_{PRB\_RA}^{lowest\_index} ( 1 ) = 15 , \\ {I}_{sequence}^{wrap \text{-} around} ( 0 ) = ( ⌊ {I}_{PRB\_RA}^{offset} ( 0 ) / {N}_{PHICH}^{group} ⌋ ) mod 2 {N}_{SF}^{PHICH} = 0 , \\ and$$

$${I}_{sequence}^{wrap \text{-} around} ( 1 ) = ( ⌊ {I}_{PRB\_RA}^{offset} ( 1 ) / {N}_{PHICH}^{group} ⌋ ) mod 2 {N}_{SF}^{PHICH} = 4 ,$$

the assigned PHICH resources are PHICH resource eleven (11) 705, i.e.,

$$( {n}_{PHICH}^{group} , {n}_{PHICH}^{seq} ) = ( 3 , 2 ) ,$$

and PHICH resource twenty-one (21) 715, i.e.,

$$( {n}_{PHICH}^{group} , {n}_{PHICH}^{seq} ) = ( 1 , 5 ) ,$$

respectively.

In another embodiment, referred to as method_{—}2-2, multiple sets of PHICH resources in a primary DL carrier are allocated for SS-A 116 (i.e., for advanced UEs). One set of PHICH resources is allocated for SS-A 116 per UL carrier. Both legacy UEs (e.g., SS 115 as a legacy UE or when SS 116 is a legacy UE) and advanced UEs (e.g., SS-A 116) obtain the number of PHICH groups

$${N}_{PHICH}^{group}$$

for one set of PHICH resources. SS 115 and SS-A 116 use Equation 3, with parameters

$${N}_{RB}^{DL}$$

and N_{g}, in order to obtain the number of PHICH groups

$${N}_{PHICH}^{group}$$

for the set of PHICH resources. However, only SS-A 116 (e.g., advanced UEs) obtains the number PHICH groups

$${N}_{PHICH , ( 1 )}^{group} , … , {N}_{PHICH , ( {N}_{carriers}^{UL} - 1 )}^{group}$$

for the other sets using

$${N}_{RB}^{DL} and {N}_{g , ( 1 )} , … , {N}_{g , ( {N}_{carriers}^{UL} - 1 )} ,$$

where subscripts (i) implies UL carrier i,

$$i = 0 , 1 , … , {N}_{carriers}^{UL} - 1.$$

The parameters

$${N}_{g , ( 1 )} , … , {N}_{g , ( {N}_{carriers}^{UL} - 1 )}$$

can be implicitly obtained by SS-A 116 from N_{g} and other parameters. Additionally or alternatively, BS 102, through higher-layer signaling, can explicitly inform SS-A 116 regarding the parameters

$${N}_{g , ( 1 )} , … , {N}_{g , ( {N}_{carriers}^{UL} - 1 )} .$$

In one example of the implicit relation,

$${N}_{g , ( 1 )} = … = {N}_{g , ( {N}_{carriers}^{UL} - 1 )} = {N}_{g} .$$

The sets of PHICH resources that are accessible only by SS-A 116 are physically mapped onto the downlink CCE resources. The CCE resources can be located either in the common search space or in a UE-specific search space. BS 102 can use higher-layer signaling to inform SS-A 116 regarding the CCE resources reserved for the PHICH resources. Therefore, a PHICH resource can be determined by the UL PRB indices and a DMRS CS index associated with the UL carrier i using Equation 1 within its set of PHICH resources, or set i.

In some alternative_{—}2 embodiments, multiple DMRS CS indices associated with multiple UL carriers are carried either: (1) explicitly in a UL grant along with other scheduling information; or obtained via (2) an implicit relation of a single DMRS CS index in a UL grant and other parameters sent by a higher-layer signaling; or (3) in broadcasted information. Examples of implicit mapping of multiple DMRS CS indices are

$${n}_{DMRS} ( i ) = {n}_{DMRS} ( 0 ) , ∀ i and$$

$${n}_{DMRS} ( i ) = ( {n}_{DMRS} ( 0 ) + i ) mod {N}_{SF}^{PHICH} , ∀ i ,$$

where n_{DMRS}(0) is carried in a UL grant and

$${N}_{SF}^{PHICH}$$

is the spreading factor size used for PHICH, as configured by higher layers. The relationships (i.e., equations) are

$${n}_{DMRS} ( i ) = {n}_{DMRS} ( 0 ) , ∀ i and$$

$${n}_{DMRS} ( i ) = ( {n}_{DMRS} ( 0 ) + i ) mod {N}_{SF}^{PHICH} , ∀ i ,$$

can be established in both SS-A 116 and BS 102 such that both are aware of what SS-A 116 will apply.

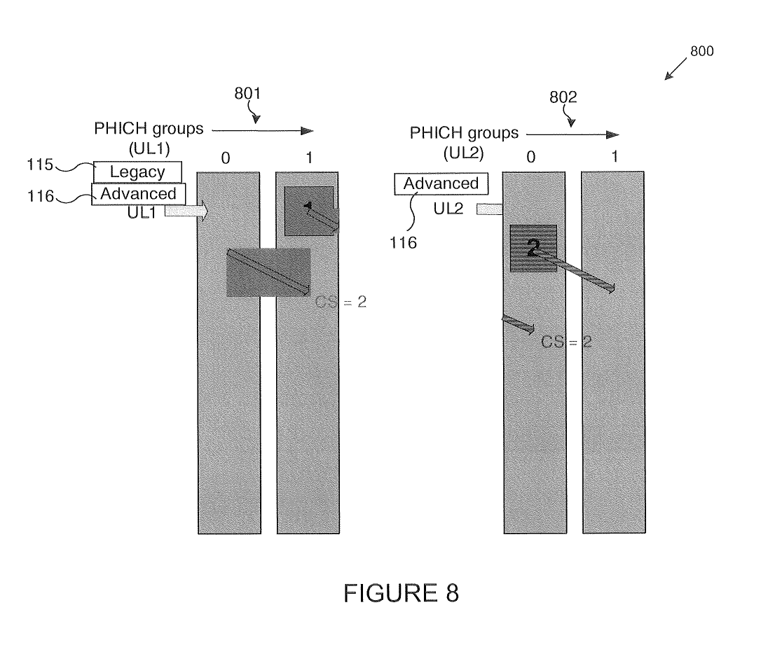

FIG. 8 illustrates another PHICH mapping method according to embodiments of the present disclosure. The embodiment of the PHICH mapping 800 shown in FIG. 8 is for illustration only. Other embodiments could be used without departing from the scope of this disclosure.

In the example illustrated in FIG. 8, the PHICH mapping 800 includes

$${N}_{PHICH}^{group} = 2 and {N}_{PHICH , ( 1 )}^{group} = 2$$

based on method_{—}2-2. In embodiments using method_{—}2-2, with

$${n}_{DMRS} ( 0 ) = {n}_{DMRS} ( 1 ) = 2 , \\ {I}_{PRB\_RA}^{lowest\_index} ( 0 ) = 1 and {I}_{PRB\_RA}^{lowest\_index} ( 1 ) = 2 ,$$

the PHICH resources assigned for a recent transmission in the UL carriers ‘1’ and ‘2’. The first carrier UL_1 is allocated the first set of PHICH resource groups 801 and the second carrier UL_2 is allocated a second set of PHICH groups 802. The PHICH Resources allocated are five (5) 805 in the first set 801 and PHICH Resource six (6) 810 in the second set 802.

For example, SS-A 116 can be allocated the first set of PHICH groups 801. SS-A 116 starts with PHICH resource one (1) (PHICH Group ‘1’ of the first set 801 and PHICH Sequence ‘0’) as the lowest PRB index in UL_1 (the first UL carrier). When the DMRS CS=2, SS-A 116 proceeds to use PHICH resource five (5). Additionally, SS-A 116 starts with PHICH resource two (2) (PHICH Group ‘0’ of the second set 802 and PHICH Sequence ‘1’) as the lowest PRB index in UL_2 (the second UL carrier). When the DMRS CS=2, SS-A 116 proceeds to use PHICH resource six (6).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communications network with asymmetric carriers, a base station capable of communicating with a plurality of subscriber stations, said base station comprising:
a transmitter configured to allocate one set of Physical Hybrid Automatic Repeat Request Indicator Channel (PHICH) resources in a downlink carrier, wherein the transmitter is configured to inform, via an uplink grant, at least one subscriber station regarding at least one PHICH resource from the allocated set of PHICH resources, and wherein the uplink grant includes:
at least one Cyclic Shift (CS) index; and
Physical Resource Block (PRB) indices for each of a plurality of uplink carriers; and
a receiver configured to receive a data communication from the at least one subscriber station within PRBs in at least one of the plurality of uplink carriers, the PRBs corresponding to the PRB indices included in the uplink grant,
wherein the transmitter further is configured to transmit an Acknowledgement/Negative Acknowledgement (ACK/NACK) on the allocated at least one PHICH resource in the downlink carrier such that one of the at least one PHICH resource is defined by the PRB index and at least one offset value.

2. The base station of claim 1, wherein, when only one PHICH resource is allocated, the transmitter further is configured to combine a plurality of Acknowledgment and Negative Acknowledgement bits into a single bit.

3. The base station of claim 1, wherein the transmitter is configured to transmit a single CS index in the uplink grant and at least one parameter transmitted via higher layer signaling, wherein an implicit relationship exists between the single CS index and a second CS index and wherein the implicit relationship depends upon the at least one parameter.

4. The base station of claim 1, wherein the transmitter is configured to allocate the one of the at least one PHICH resource further defined by a mapping method based on one of the PRB indices corresponding to one of the uplink carriers, the CS index, and the offset value.

5. The base station of claim 4, wherein the mapping method further is defined by the equations:
$${n}_{PHICH}^{group} ( i ) = ( {I}_{PRB\_RA}^{offset} ( i ) + {I}_{PRB\_RA}^{lowest\_index} ( i ) + {n}_{DMRS} ( i ) ) mod {N}_{PHICH}^{group} , \\ {n}_{PHICH}^{seq} ( i ) = ( ⌊ ( \begin{matrix}{I}_{PRB\_RA}^{offset} ( i ) + \\ {I}_{PRB\_RA}^{lowest\_index} ( i )\end{matrix} ) / {N}_{PHICH}^{group} ⌋ + {n}_{DRMS} ( i ) ) mod 2 {N}_{SF}^{PHICH} ,$$
wherein “i” is an uplink carrier index,
$${I}_{PRB\_RA}^{lowest\_index} ( i )$$
is a smallest UL PRB index corresponding to a carrier “i”, n_{DMRS}(i) is a DMRS CS index corresponding to the carrier “i”,
$${I}_{PRB\_RA}^{offset} ( i )$$
is an UL PHICH offset index corresponding to the carrier “i”,
$${N}_{SF}^{PHICH}$$
is a spreading factor,
$${N}_{PHICH}^{group}$$
is a number of PHICH groups configured,
$${n}_{PHICH}^{group} ( i )$$
is a PHICH group number corresponding to the carrier “i” and
$${n}_{PHICH}^{seq} ( i )$$
is an orthogonal sequence index within a group corresponding to the carrier “i”.

6. The base station of claim 4, wherein the mapping method further is based on a wraparound value.

7. The base station of claim 1, wherein each of a plurality of the at least one offset values uniquely corresponds to a respective component carrier among the at least one of the plurality of uplink carriers.

8. The base station of claim 7, wherein the at least one offset value is configured to evenly divide the set of PHICH resources based on a number of uplink carriers and is defined by:
$${I}_{PRB \_ RA}^{offset} ( i ) = ⌊ i {N}_{PHICH}^{resources} / {N}_{carriers}^{UL} ⌋$$
wherein “i” is an uplink carrier index,
$${I}_{PRB \_ RA}^{offset} ( i )$$
is the offset value corresponding to the carrier “i”,
$${N}_{PHICH}^{resources}$$
is a number of PHICH resources and
$${N}_{carriers}^{UL}$$
is a number of uplink carriers.

9. For use in a wireless communications system comprising a plurality of base stations capable of communicating with a plurality of subscriber stations via asymmetric carriers, at least one of the plurality of subscriber stations comprising:
a receiver configured to receive an uplink grant from a base station, wherein the uplink grant indicates an allocation of at least one Physical Hybrid Automatic Repeat Request Indicator Channel (PHICH) resource in a downlink carrier, the at least one PHICH resource included in one set of PHICH resources allocated in the downlink carrier, and wherein the uplink grant includes:
at least one Cyclic Shift (CS) index; and
Physical Resource Block (PRB) indices for each of a plurality of uplink carriers; and
a transmitter configured to send a data communication to the base station within PRBs in at least one of the plurality of uplink carriers, the PRBs corresponding to the PRB indices included in the uplink grant,
wherein the receiver further is configured to receive an Acknowledgement/Negative Acknowledgement (ACK/NACK) on the allocated at least one PHICH resource in the downlink carrier such that one of the at least one PHICH resource is defined by the PRB index and at least one offset value.

10. The subscriber station of claim 9, wherein, when only one PHICH resource is allocated, the receiver further is configured to receive a single bit representing a plurality of Acknowledgment and Negative Acknowledgement bits in the PHICH resource, wherein the plurality of Acknowledgment and Negative Acknowledgement bits are combined into the single bit.

11. The subscriber station of claim 9, wherein the receiver is configured to receive a single CS index in the uplink grant and at least one parameter received via higher layer signaling, wherein an implicit relationship exists between the single CS index and a second CS index and wherein the implicit relationship depends upon the at least one parameter.

12. The subscriber station of claim 9, wherein the allocation the one of the at least one PHICH resource further is defined by a mapping method based on one of the PRB indices corresponding to one of the uplink carriers, the CS index, and the offset value.

13. The subscriber station of claim 12, wherein the mapping method further is defined by the equations:
$${n}_{PHICH}^{group} ( i ) = ( {I}_{PRB \_ RA}^{offset} ( i ) + {I}_{PRB \_ RA}^{lowest \_ index} ( i ) + {n}_{DMRS} ( i ) ) mod {N}_{PHICH}^{group} , \\ {n}_{PHICH}^{seq} ( i ) = ( \begin{matrix}⌊ \frac{( {I}_{PRB \_ RA}^{offset} ( i ) + {I}_{PRB \_ RA}^{lowest \_ index} ( i ) )}{{N}_{PHICH}^{group}} ⌋ + \\ {n}_{DMRS} ( i )\end{matrix} ) mod 2 {N}_{SF}^{PHICH} ,$$
wherein “i” is an uplink carrier index,
$${I}_{PRB \_ RA}^{lowest \_ index} ( i )$$
is a smallest UL PRB index corresponding to a carrier “i”, n_{DMRS}(i) is a DMRS CS index corresponding to the carrier “i”,
$${I}_{PRB \_ RA}^{offset} ( i )$$
is an UL PHICH offset index corresponding to the carrier “i”,
$${N}_{SF }^{PHICH}$$
is a spreading factor,
$${N}_{PHICH}^{group}$$
is a number of PHICH groups configured,
$${n}_{PHICH}^{group} ( i )$$
is a PHICH group number corresponding to the carrier “i” and
$${n}_{PHICH}^{seq} ( i )$$
is an orthogonal sequence index within a group corresponding to the carrier “i”.

14. The subscriber station of claim 12, wherein the mapping method further is based on a wraparound value.

15. The subscriber station of claim 9, wherein each of a plurality of the at least one offset values uniquely corresponds to a respective component carrier in the at least one of the plurality of uplink carriers.

16. The subscriber station of claim 15, wherein a plurality of PHICH resources is evenly divided based on a number of uplink carriers and is defined by:
$${I}_{PRB \_ RA}^{offset} ( i ) = ⌊ i {N}_{PHICH}^{resources} / {N}_{carriers}^{UL} ⌋$$
wherein “i” is an uplink carrier index,
$${I}_{PRB \_ RA}^{offset} ( i )$$
is the offset value corresponding to the carrier “i”,
$${N}_{PHICH}^{resources}$$
is a number of PHICH resources and
$${N}_{carriers}^{UL}$$
is a number of uplink carriers.

17. A method for allocating resources in a wireless communications network with asymmetric carriers, the method comprising:
allocating a set of Physical Hybrid Automatic Repeat Request Indicator Channel (PHICH) resources in a downlink carrier;
informing, via an uplink grant, at least one subscriber station regarding an allocation of at least one PHICH resource included in the allocated set of PHICH resources, and wherein the uplink grant includes:
at least one Cyclic Shift (CS) index; and
Physical Resource Block (PRB) indices for each of a plurality of uplink carriers; and
receiving, via at least one of a plurality of uplink carriers, a data communication from the at least one subscriber station within PRBs in at least one of the plurality of uplink carriers, the PRBs corresponding to the PRB indices included in the uplink grant; and
transmitting an Acknowledgement/Negative Acknowledgement (ACK/NACK) on the allocated at least one PHICH resource in the downlink carrier such that one of the at least one PHICH resource is defined by the PRB index and at least one offset value.

18. The method of claim 17, wherein, when only one PHICH resource is allocated, transmitting further comprises combining a plurality of Acknowledgment and Negative Acknowledgement bits into a single bit and transmitting the single bit to represent the plurality of Acknowledgment and Negative Acknowledgement bits.

19. The method of claim 17, further comprising:
transmitting a single CS index in the uplink grant and at least one parameter transmitted via higher layer signaling, wherein an implicit relationship exists between the single CS index and a second CS index and wherein the implicit relationship depends upon the at least one parameter.

20. The method of claim 17, further comprising allocating the at least one PHICH resource using a mapping method based on the PRB index corresponding to one of the uplink carriers the CS index, and the offset value.

21. The method of claim 20, wherein the mapping method further is defined by the equations:
$${n}_{PHICH}^{group} ( i ) = ( {I}_{PRB \_ RA}^{offset} ( i ) + {I}_{PRB \_ RA}^{lowest \_ index} ( i ) + {n}_{DMRS} ( i ) ) mod {N}_{PHICH}^{group} , \\ {n}_{PHICH}^{seq} ( i ) = ( \begin{matrix}⌊ \frac{( {I}_{PRB \_ RA}^{offset} ( i ) + {I}_{PRB \_ RA}^{lowest \_ index} ( i ) )}{{N}_{PHICH}^{group}} ⌋ + \\ {n}_{DMRS} ( i )\end{matrix} ) mod 2 {N}_{SF}^{PHICH} ,$$
wherein “i” is an uplink carrier index,
$${I}_{PRB \_ RA}^{lowest \_ index } ( i )$$
is a smallest UL PRB index corresponding to a carrier “i”, n_{DMRS}(i) is a DMRS CS index corresponding to the carrier “i”,
$${I}_{PRB \_ RA}^{offset} ( i )$$
is an UL PHICH offset index corresponding to the carrieris a “i”,
$${N}_{SF}^{PHICH}$$
is a spreading factor,
$${N}_{PHICH}^{group}$$
is a number of PHICH groups configured,
$${n}_{PHICH}^{group} ( i )$$
is a PHICH group number corresponding to the carrier “i” and
$${n}_{PHICH}^{seq} ( i )$$
is an orthogonal sequence index within a group corresponding to the carrier “i”.

22. The method of claim 20, wherein the mapping method further is based on a wraparound value.

23. The method of claim 17, wherein each of a plurality of the at least one offset values uniquely corresponds to a respective component carrier in at least one of the plurality of uplink carriers.

24. The method of claim 23, further comprising allocating the at least one PHICH resource by dividing evenly the set of PHICH resources based on a number of uplink carriers and is defined by:
$${I}_{PRB \_ RA}^{offset} ( i ) = ⌊ i {N}_{PHICH}^{resources} / {N}_{carrriers}^{UL} ⌋$$
wherein “i” is an uplink carrier index,
$${I}_{PRB \_ RA}^{offset} ( i )$$
is the offset value corresponding to the carrier “i”,
$${N}_{PHICH}^{resources}$$
is a number of PHICH resources and
$${N}_{carriers}^{UL}$$
is a number of uplink carriers.
